(19) United States
(12) Patent Application Publication
(10) Pub. No.: US 2005/0018660 A1
(43) Pub. Date: Jan. 27, 2005

(54) Speaker call-history presentation system, speaker call-history presentation method, IP telephone set, IP telephone method and program

(75) Inventor: Tomoyuki Hayashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation

(21) Appl. No.: 10/895,898

(22) Filed: Jul. 22, 2004

(30) Foreign Application Priority Data
Jul. 23, 2003 (JP) 278254 / 2003

(51) Int. Cl. H04L 12/66

(52) U.S. Cl. 370/352

(57) ABSTRACT

According to an instruction of an operator of an IP telephone set 1, the IP telephone set 1 transfers a received signal transmitted from a caller, who is making a call, to a voiceprint collation server 2. Thereafter, the IP telephone set 1 receives and displays data on the caller's past call, which is transmitted from the voiceprint collation server 2 in response to the transfer described above. The voiceprint collation server 2 receives the received signal transferred from the IP telephone set 1, fetches voiceprint data from the received signal and transmits the data on the caller's past call, which is related to the voiceprint data, to the IP telephone set 1.

### BACKGROUND OF THE INVENTION

1. Field of the Invention

The present invention relates to a speaker call-history presentation system and an IP telephone set, more particularly to a speaker call-history presentation system for presenting a caller's call-history and an IP telephone set.

2. Description of the Related Prior Art

As a communication device for specifying a caller, for example, there has been heretofore a device as disclosed in Japanese Patent Laid-Open No. 2000-324230. This device relates voiceprint data and personal data (for example, a name and the like) to each other and registers the related data beforehand in a database. Upon receipt of a voice of an opposite communication partner (caller) via a communication terminal connected to the device, the device generates voiceprint data based on this received voice. Thereafter, the device checks whether this generated voiceprint data exits in the data base or not. When the generated voiceprint data exists in the data base, the device fetches the personal data related to the voiceprint data in the data base and notifies a communication partner (recipient) of this personal data.

As described above, by checking whether the voiceprint data exists in the data base or not, the conventional communication device specifies the caller of the voice transferred from the communication terminal. Accordingly, the device notifies the communication partner (recipient), who communicates with the caller, only of the caller's personal data (a name of the caller and the like). Therefore, even when the call is a suspicious call, the recipient only knows the name of the caller and the like, and cannot promptly Figure out whether the call is a suspicious caller or not. Consequently, the recipient is suffered with inconvenience wasting his/her time.

The suspicious call is a call intended for solicitation, sales and the like of, such as real estate, stocks, religions and the like.

### SUMMARY OF THE INVENTION

A first speaker call-history presentation system of the present invention includes: an IP telephone set which transfers a received signal transmitted from a caller, who is making a call, to a voiceprint collation server and receives and displays data on the caller's past call, which is transmitted from the voiceprint collation server in response to the transfer; and the voiceprint collation server which receives the received signal transferred from the IP telephone set, fetches voiceprint data from the received signal and transmits data on the caller's past call, which is related to the voiceprint data, to the IP telephone set.

A second speaker call-history presentation system of the present invention includes: an IP telephone set which transfers a received signal transmitted from a caller, who is making a call, to a voiceprint collation server, receives data on the caller's past call, which is transmitted from the voiceprint collation server in response to the transfer, and outputs the past call data to a terminal device; the terminal device which receives and displays the data on the caller's past call, which is outputted by the IP telephone set; and the voiceprint collation server which receives the received signal transferred from the IP telephone set, fetches voiceprint data from the received signal and transmits data on the caller's past call, which is related to the voiceprint data, to the IP telephone set.

A third speaker call-history presentation system of the present invention includes: an IP telephone set which transfers a received signal transmitted from a caller, who is making a call, to a voiceprint collation server; a terminal device which receives and displays data on the caller's past call, which is transmitted from the voiceprint collation server in response to the transfer of the received signal to the voiceprint collation server by the IP telephone set; and the voiceprint collation server which receives the received signal transferred from the IP telephone set, fetches voiceprint data from the received signal and transmits data on the caller's past call, which is related to the voiceprint data, to the terminal device.

The IP telephone set of the present invention includes: received signal transfer means for transferring a received signal transmitted from the caller, who is making a call, to a transfer destination having a predetermined IP address; and call data display means for receiving and displaying the data on the caller's past call which the transfer destination transmits in response to the transfer.

A first IP telephone system of the present invention includes: an IP telephone set which transfers a received signal transmitted from a caller, who is making a call, to a transfer destination having a predetermined IP address, receives and outputs the data on the caller's past call which is transmitted from the transfer destination in response to the transfer; and a terminal device which receives and displays the data on the caller's past call, which is outputted by the IP telephone set.

A second IP telephone system of the present invention includes: an IP telephone set which transfers a received signal transmitted from a caller, who is making a call, to a transfer destination having a predetermined IP address; and a terminal device which receives and displays the data on the caller's past call which the transfer destination transmits in response to the transfer of the received signal from the caller by the IP telephone set.

A first IP telephone method of the present invention includes: receiving a received signal transmitted from a caller, who is making a call, and transferring the received signal to a transfer destination having a predetermined IP address; and receiving and displaying data on the caller's past call, which is transmitted from the transfer destination in response to the transfer.

A second IP telephone method of the present invention includes: receiving a received signal transmitted from a caller, who is making a call, and transferring the received signal to a transfer destination having a predetermined IP address; and receiving data on the caller's past call, which is transmitted from the transfer destination in response to the transfer, and outputting the received call data so as to have the call data displayed.

A first speaker call-history presentation method of the present invention includes: transferring a received signal transmitted from a caller, who is making a call, by an IP telephone set; receiving the received signal transferred from the IP telephone set and fetching voiceprint data from this received signal by a voiceprint collation server; transmitting data on the caller's past call, which is related to the fetched voiceprint data, to the IP telephone set by the voiceprint collation server; and receiving and displaying the data on the caller's past call which is transmitted from the voiceprint collation server, by the IP telephone set.

A second speaker call-history presentation method of the present invention includes: transferring a received signal transmitted from a caller, who is making a call, by an IP telephone set; receiving the received signal transferred from the IP telephone set and fetching voiceprint data from this received signal by a voiceprint collation server; transmitting data on the caller's past call, which is related to the fetched voiceprint data, to the IP telephone set by the voiceprint collation server; receiving and outputting the data on the caller's past call, which is transmitted from the voiceprint collation server, by the IP telephone set; and receiving and displaying the data on the caller's past call, which is outputted by the IP telephone set, by a terminal device.

A third speaker call-history presentation method of the present invention includes: transferring a received signal transmitted from a caller, who is making a call, by an IP telephone set; receiving the received signal transferred from the IP telephone set and fetching voiceprint data from this received signal by a voiceprint collation server; transmitting data on the caller's past call, which is related to the fetched voiceprint data, by the voiceprint collation server; and receiving and displaying the data on the caller's past call, which is transmitted from the voiceprint collation server, by a terminal device.

### BRIEF DESCRIPTION OF THE DRAWINGS

The objects, features and advantages of the present invention will become apparent from the following detailed description when taken with the accompanying drawings in which:

FIG. 1 is a block diagram showing a first embodiment of a speaker call-history presentation system of the present invention;

FIG. 2 is a block diagram showing one configuration example of an IP telephone set;

FIG. 3 is a view showing one configuration example of a VoIP signal;

FIG. 4 is a flowchart showing one example of operations of the first embodiment;

FIG. 5 is a block diagram showing a second embodiment of the speaker call-history presentation system of the present invention;

FIG. 6 is a block diagram showing one configuration example of the IP telephone set;

FIG. 7 is a flowchart showing one example of operations of the second embodiment;

FIG. 8 is a block diagram showing a third embodiment of the speaker call-history presentation system of the present invention;

FIG. 9 is a block diagram showing one configuration example of the IP telephone set; and.

FIG. 10 is a flowchart showing one example of operations of the third embodiment.

### DETAILED DESCRIPTION OF THE PREFERRED EMBODIMENTS

Next, with reference to the drawings, embodiments of the present invention will be described.

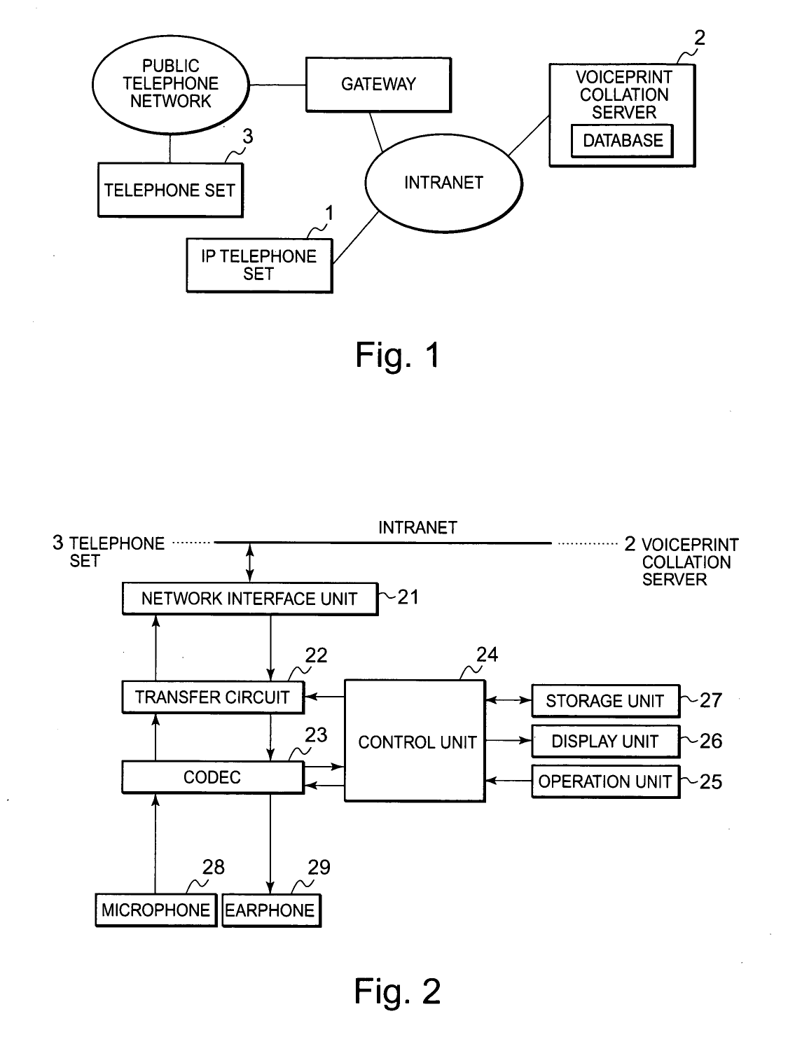

FIG. 1 is a block diagram showing a first embodiment of a speaker call-history presentation system of the present invention.

This embodiment shown in FIG. 1 includes an IP telephone set 1, a voiceprint collation server 2, and a telephone set 3.

The voiceprint collation server 2 is connected to the IP telephone set 1 through a network such as an intranet.

The telephone set 3 is connected to the IP telephone set 1 through a public telephone network, a gateway and the intranet, and makes a call to the IP telephone set 1.

The IP telephone set 1 receives the call from the telephone set 3. The IP telephone set 1 receives a received signal transmitted from a caller, who is making the call using the telephone set 3 (a received signal transmitted from the telephone set 3) based on an operation of an operator, and transfers this received signal to the voiceprint collation server 2. The IP telephone set 1 receives and displays data on the caller's past call, which is transmitted from the voiceprint collation serer 2 in response to the transfer described above.

The received signal described above is a VoIP (Voice over Internet Protocol) signal, and will be hereinafter referred to as a VoIP signal.

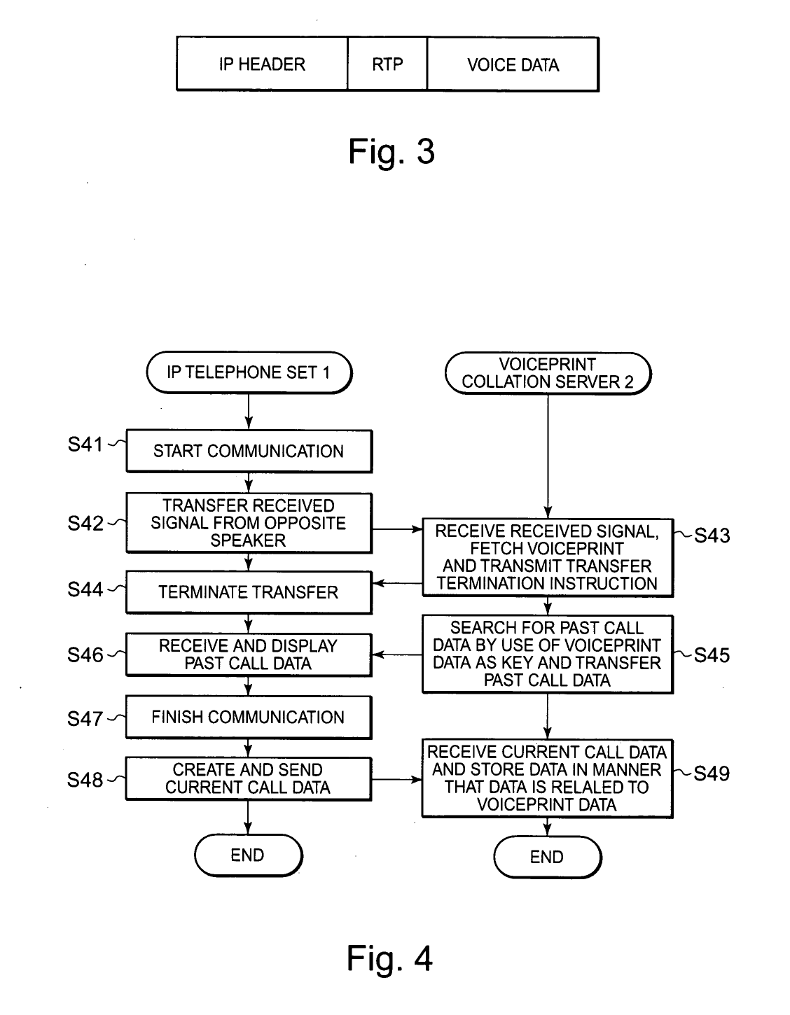

As shown in FIG. 3, the VoIP signal (VoIP packet) includes an IP header, a RTP (Real Time Transport Protocol), voice data and the like. The IP header includes a destination IP address and a source IP address. The RTP includes information required to reproduce the voice data. This information includes sequence numbers of packets, time stamps and the like.

Moreover, the call data is, for example, text data including the name of the caller, the date and time of the call, a brief summary of the call and the like. A brief summary of the call, for example, states that the call is a suspicious call intended for solicitation, sales and the like of, such as real estate, stocks, religions and the like.

The voiceprint collation server 2 receives the VoIP signal transferred from the IP telephone set 1 and fetches voiceprint data from this VoIP signal. Thereafter, the voiceprint collation server 2 searches for data on the caller's past call by use of the fetched voiceprint data as a search key and transmits this searched call data to the IP telephone set 1.

The IP telephone set 1 creates call data on a current call from the caller based on an operation of the operator, and sends this current call data to the voiceprint collation server 2. The voiceprint collation server 2 receives the current call data from the IP telephone set 1. Thereafter, the voiceprint collation server 2 stores the received call data together with the data on the caller's past call in a manner that the received call data is related to the voiceprint data fetched from the VoIP signal.

As shown in FIG. 2, the IP telephone set 1 includes a network interface unit 21, a transfer circuit 22, a CODEC (CODER DECORDER) 23, a microphone 28, an earphone 29, an operation unit 25, a storage unit 27, a control unit 24 and a display unit (device) 26.

The network interface unit 21 receives/transmits the VoIP signal (VoIP packet) from/to the telephone set 3 and the voice print collation server 2 through the intranet. One network interface unit 21 enables communication with multiple points.

The transfer circuit 22 outputs the VoIP packet, which has been received from the telephone set 3 by the network interface unit 21, to the CODEC 23. However, upon receipt of an instruction to transfer from the control unit 24, the transfer circuit 22 copies the VoIP packet, which has been received from the telephone set 3 by the network interface unit 21. Thereafter, the transfer circuit 22 changes the destination IP address of the copied packet to the IP address of the voiceprint collation server 2 and the source IP address thereof to the IP address of the IP telephone set 1. Subsequently, the transfer circuit 22 transfers the changed VoIP packet to the voiceprint collation server 2 through the network interface unit 21. Moreover, the transfer circuit 22 outputs a VoIP packet transmitted from the CODEC 23 to the network interface unit 21.

The CODEC 23 converts a voice signal transmitted from the microphone 28 into a VoIP packet and outputs the packet to the transfer circuit 22. Moreover, the CODEC 23 converts the VoIP packet transmitted from the transfer circuit 22 into a voice signal and outputs the voice signal to the earphone 29.

The operation unit 25 receives operations of the operator such as input of a telephone number and picking up/hanging up of the phone. Moreover, the operation unit 25 includes a transfer button and outputs a transfer instruction to transfer the received signal (VoIP signal), which is transmitted from the telephone set 3 (caller), to the voiceprint collation server 2. Furthermore, the operation unit 25 creates call data and store the call data in the storage unit 27 based on an operation by the operator.

The storage unit 27 stores the call data created based on the operation of the operator.

The display unit 26 performs display of the past call data, display of the call data created based on the operation of the operator, display of states of the telephone set and the like.

The control unit 24 controls communication with the telephone set 3, communication with the voiceprint collation server 2 and the functions of the IP telephone set 1. Moreover, the control unit 24 receives the transfer instruction outputted by the operation unit 25 and instructs the transfer circuit 22 to transfer.

Next, with reference to FIG. 4, detailed description will be given of operations of the speaker call-history presentation system of this embodiment.

FIG. 4 is a flowchart showing one example of the operations of this embodiment.

In Step 41 of FIG. 4, a person, who is to be a caller to the operator of the IP telephone set 1 in FIG. 1, uses the telephone set 3 to make a call to the IP telephone set 1. The telephone set 3 is connected to the IP telephone set 1 through the public telephone network, the gateway and the intranet. Thereafter, the IP telephone set 1 receives the call from the telephone set 3 and starts communication with the caller according to an instruction of the operator.

In Step 42 of FIG. 4, the operator of the IP telephone set 1 listens to contents of the call. When the operator determines that the call may be a suspicious call based on the contents of the communication, the operator operates transfer instruction device. The transfer instruction device is, for example, the transfer button, which is set in the IP telephone set 1. The transfer instruction device outputs, to the control unit 24, a transfer signal having an instruction to transfer a received signal (VoIP signal) transmitted from the caller. Transfer circuit 22 in the IP telephone set 1 receives the transfer signal via the control unit 24 and starts to transfer the VoIP signal to the voiceprint collation server 2 having a predetermined IP address which is a transfer destination.

In Step 43 of FIG. 4, the voiceprint collation server 2 receives the VoIP signal transferred from the IP telephone set 1 and fetches voiceprint data from this signal. Thereafter, the voiceprint collation server 2 transmits a transfer termination instruction to instruct termination of the transfer of the VoIP signal, to the IP telephone set 1.

In Step 44 of FIG. 4, the IP telephone 1 receives the transfer termination instruction transmitted by the voiceprint collation server 2, and terminates the transfer of the VoIP signal, which is started in Step 42.

In Step 45 of FIG. 4, the voiceprint collation server 2 uses the voiceprint data fetched in Step 43 (S43) as a search key to search for call data in a database, which is set in the voiceprint collation server 2. In the database, call data on the past call is stored in a manner that the call data is related to the voiceprint data. When the voiceprint collation server 2 can search for the call data related to the voiceprint data fetched in Step 43 (S43), the voiceprint collation server 2 transmits this call data to the IP address of the IP telephone set 1, which is included in the VoIP signal. The call data described above is data when the person having a voiceprint with the voiceprint data fetched in Step 43 (S43) made a call to the operator of the IP telephone set 1 in the past.

When the voiceprint collation server 2 cannot search for the call data related to the voiceprint data fetched in Step 43 (S43), the voiceprint collation server 2 operates as below. That is, the voiceprint collation server 2 determines that the person having a voiceprint with the voiceprint data has made a call to the IP telephone set 1 for the first time. Accordingly, the voiceprint collation server 2 transmits a “notification indicating the first call” to the IP address of the IP telephone set 1, which is included in the VoIP signal.

In Step 46 of FIG. 4, the IP telephone set 1 having the IP address included in the VoIP signal receives the data on the caller's past call or the “notification indicating the first call” from the voiceprint collation server 2. Thereafter, the display unit 26 of the IP telephone set 1 displays the past call data or the “notification indicating the first call”.

In Step 47 of FIG. 4, when the contents displayed on the display unit 26 are the past call data, the operator of the IP telephone set 1 knows the contents of the call made by the caller in the past by reading the past call data. Thus, the operator can promptly determine whether or not the current call is a suspicious one intended for solicitation, sales and the like of, such as real estate, stocks, religions and the like. Accordingly, when the call is such a suspicious call, the operator can deal with the call by immediately sending a negative reply, hanging up the phone, finishing the call or the like.

Moreover, when the displayed contents are the “notification indicating the first call”, the operator of the IP telephone set 1 determines the purpose of the call and deals therewith while listening to the caller. Thereafter., the operator hangs up the phone and finishes the call.

In Step 48 of FIG. 4, after the call between the IP telephone set 1 and the telephone set 3 is finished, the IP telephone set 1 creates call data on this call based on an operation of the operator. For example, the operator operates the operation unit 25 to create call data, including the name of the caller, the date and time of the call, a brief summary of the call and the like, as text data and stores the call data in the storage unit 27. Thereafter, the operator sends the call data stored in the storage unit 27 to the voiceprint collation server 2.

In Step 49 of FIG. 4, upon receipt of the call data described above, the voiceprint collation server 2 stores the call data in the database. In the database, the call data described above is stored in a manner that the call data is related to the voiceprint data fetched from the latest VoIP signal transferred from the IP telephone set 1. When the data on the caller's past call is already stored in the database, the call data described above is stored therein together with the past call data.

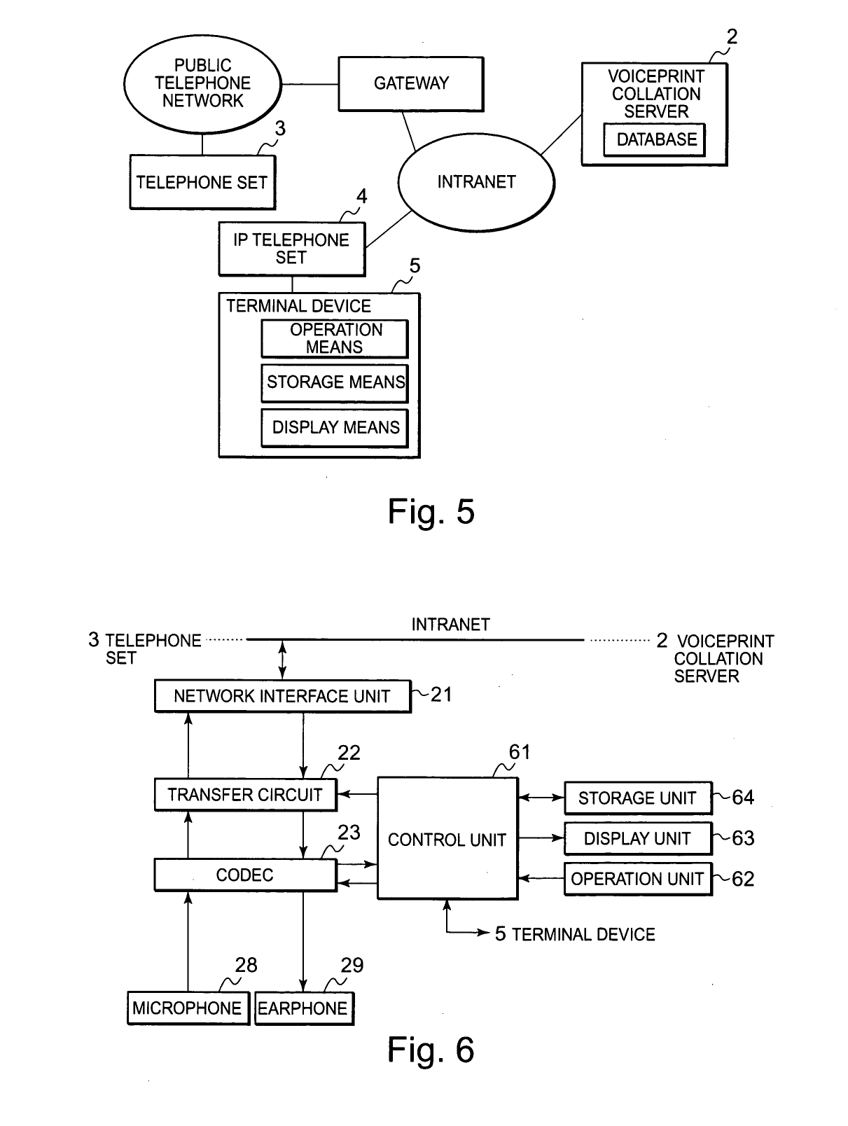

FIG. 5 is a block diagram showing a second embodiment of the speaker call-history presentation system of the present invention.

In the second embodiment, the same constituent components as those in the first embodiment will be denoted by the same reference numerals and names, and description thereof will be omitted.

This embodiment shown in FIG. 5 includes a terminal device 5 such as a personal computer, an IP telephone set 4 connected to the terminal device 5, a voiceprint collation server 2 and a telephone set 3.

The voiceprint collation server 2 is connected to the IP telephone set 4 through a network such as an intranet.

The telephone set 3 is connected to the IP telephone set 4 through a public telephone network, a gateway and the intranet, and makes a call to the IP telephone set 4.

The terminal device 5 is placed close to the IP telephone set 4 and operated by an operator of the IP telephone set 4.

The second embodiment is different from the first embodiment in that the terminal device 5 is connected to the IP telephone set 4.

The IP telephone set 4 receives a call from the telephone set 3. Based on an operation of the operator, the IP telephone set 4 receives a received signal (VoIP signal) from a caller, who is making a call using the telephone set 3, and transfers this received signal to the voiceprint collation server 2. The IP telephone set 4 receives and outputs data on the caller's past call, which is transmitted from the voiceprint collation serer 2 in response to the transfer described above.

The terminal device 5 receives and displays the data on the caller's past call, which is outputted by the IP telephone set 4.

The voiceprint collation server 2 receives the VoIP signal transferred from the IP telephone set 4 and fetches voiceprint data from this VoIP signal. Thereafter, the voiceprint collation server 2 searches for data on the caller's past call by use of the fetched voiceprint data as a search key and transmits this searched call data to the IP telephone set 4.

Based on an operation of the operator, the terminal device 5 creates call data on a current call from the caller and sends this current call data to the voiceprint collation server 2 via the IP telephone set 4. The voiceprint collation server 2 receives the current call data from the terminal device 5 via the IP telephone set 4. Thereafter, the voiceprint collation server 2 stores the received call data together with the data on the caller's past call in a manner that the received call data is related to the voiceprint data fetched from the VoIP signal.

As shown in FIG. 6, the IP telephone set 4 is different from the IP telephone set 1 in that the terminal device 5 is connected to the IP telephone set 4 and the functions of the display unit 26, operation unit 25 and storage unit 27 of the IP telephone set 1 are partly placed under the control of the terminal device 5.

An operation unit 62 receives operations of the operator such as input of a telephone number and picking up/hanging up of the phone. Moreover, the operation unit 62 includes a transfer button and outputs a transfer instruction to transfer a received signal (VoIP signal) transmitted from the telephone set 3 (opposite speaker), to the voiceprint collation server 2.

A display unit 63 performs display of states of the telephone set and the like.

A control unit 61 controls communication with the telephone set 3, communication with the voiceprint collation server 2, and the functions of the IP telephone set 4. Moreover, the control unit 61 receives the transfer instruction outputted by the operation unit 62 and instructs the transfer circuit 22 to transfer. Furthermore, the control unit 61 transmits/receives data to/from the terminal device 5.

The terminal device 5 includes operation means, display means and storage means.

Based on an operation of the operator, the operation means creates call data and stores the call data in the storage means.

The storage means stores the call data created based on the operation of the operator.

The display means performs display of the past call data, display of the call data created based on the operation of the operator, and the like.

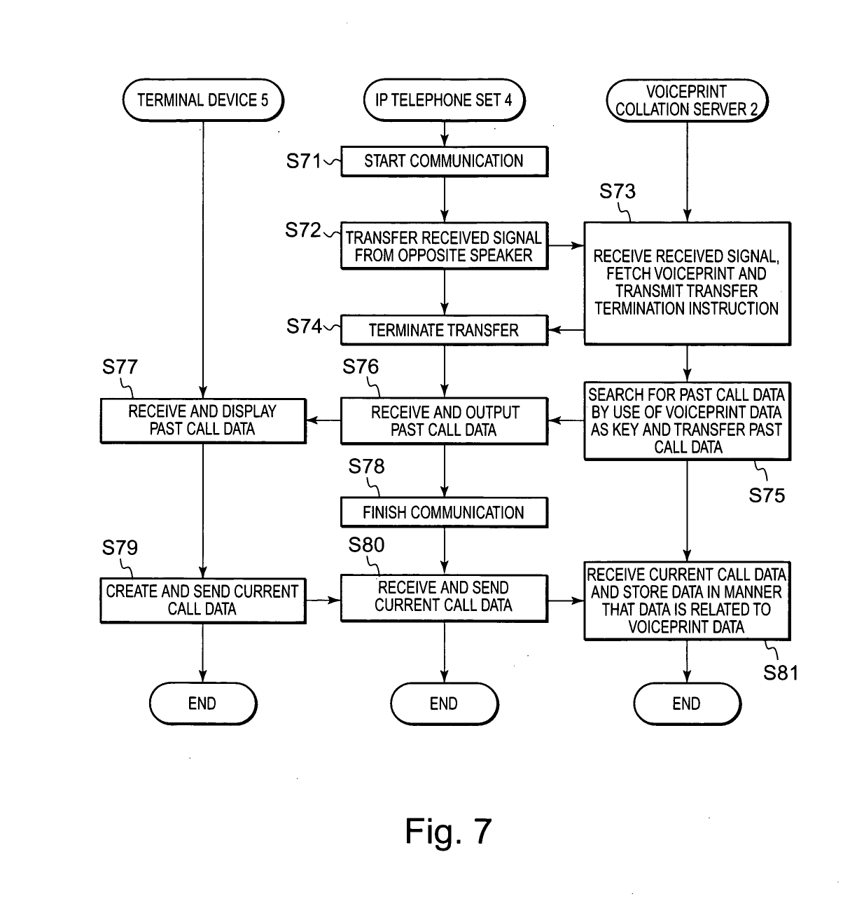

Next, with reference to FIG. 7, detailed description will be given of operations of the speaker call-history presentation system of this embodiment.

FIG. 7 is a flowchart showing one example of the operations of this embodiment.

In FIG. 5, Steps 71 to 75 of FIG. 7 are the same as Steps 41 to 45 in the description of the operations of the first embodiment shown in FIG. 1. Note that the IP telephone set 1 in Steps 41 to 45 is replaced with the IP telephone set 4.

Next, in Step 76 of FIG. 7, the IP telephone set 4 having an IP address included in the VoIP signal receives the data on the caller's past call or a “notification indicating the first call” from the voiceprint collation server 2, and outputs the past call data or the notification to the terminal device 5.

In Step 77 of FIG. 7, the terminal device 5 receives the data on the caller's past call or the “notification indicating the first call” from the IP telephone set 4, and displays the past call data or the notification on the display means thereof.

In Step 78 of FIG. 7, when the contents displayed on the display means are the past call data, the operator of the IP telephone set 4 knows contents of the call made by the caller in the past, by reading the past call data. Thus, the operator can promptly determine whether or not the current call is a suspicious one intended for solicitation, sales and the like of, such as real estate, stocks, religions and the like. Accordingly, when the call is such a suspicious call, the operator can deal with the call by immediately sending a negative reply, hanging up the phone, finishing the call or the like.

Moreover, when the contents displayed on the display means are the “notification indicating the first call”, the operator of the IP telephone set 4 determines the purpose of the call and deals therewith while listening to the caller. Thereafter, the operator hangs up the phone and finishes the call.

In Step 79 of FIG. 7, after the call between the IP telephone set 4 and the telephone set 3 is finished, the terminal device 5 creates call data on this call based on an operation of the operator. For example, the operator operates the operation means to create call data, including the name of the caller, the date and time of the call, a brief summary of the call and the like, as text data and stores the call data in the storage means. Thereafter, the operator sends the call data stored in the storage means to the IP telephone set 4.

In Step 80 of FIG. 7, the IP telephone set 4 sends the call data described above to the voiceprint collation server 2.

In Step 81 of FIG. 7, upon receipt of the call data sent by the IP telephone set 4 in Step 80, the voiceprint collation server 2 stores the call data in the database. In the database, the call data described above is stored in a manner that the call data is related to the voiceprint data fetched from the latest VoIP signal transferred from the IP telephone set 4. When the data on the caller's past call is already stored in the database, the call data described above is stored therein together with the past call data.

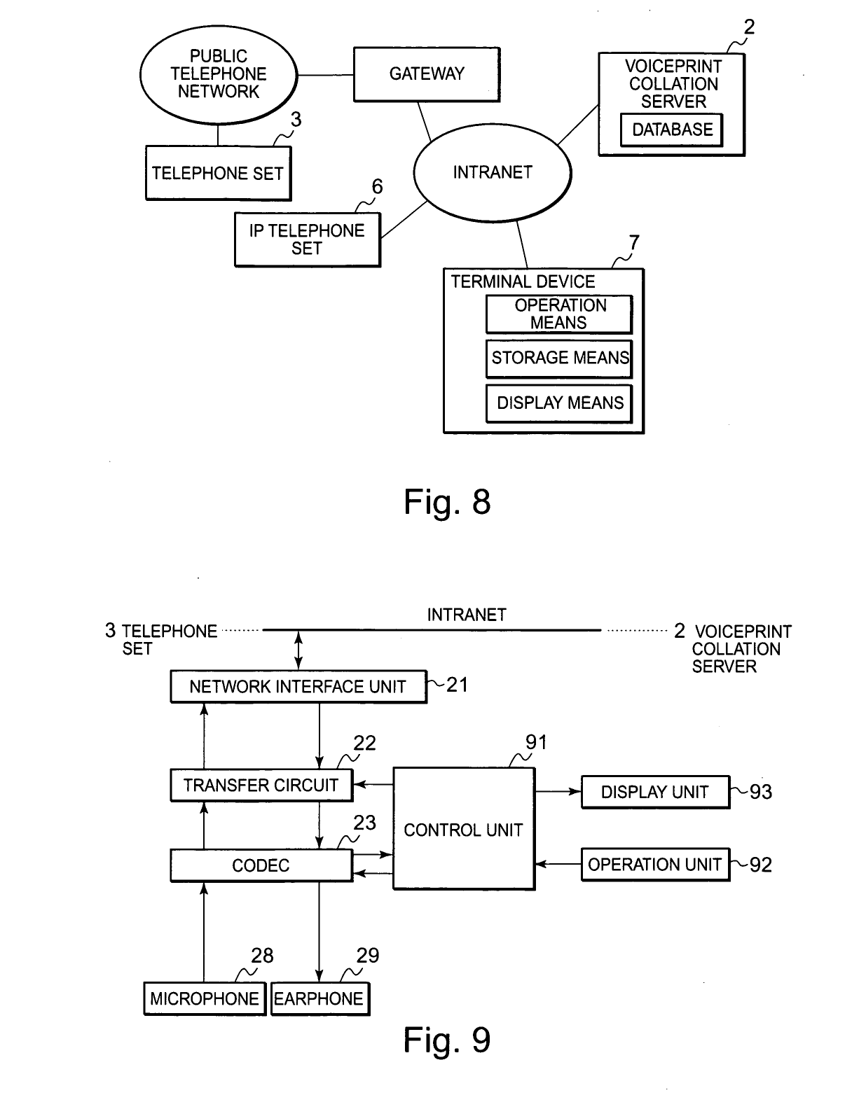

FIG. 8 is a block diagram showing a third embodiment of the speaker call-history presentation system of the present invention.

In the third embodiment, the same constituent components as those in the first embodiment will be denoted by the same reference numerals and names, and description thereof will be omitted.

This embodiment shown in FIG. 8 includes an IP telephone set 6, a terminal device 7 such as a personal computer, a voiceprint collation server 2 and a telephone set 3.

The voiceprint collation server 2 is connected to the IP telephone set 6 and the terminal device 7 through a network such as an intranet.

The telephone set 3 is connected to the IP telephone set 6 through a public telephone network, a gateway and the intranet and makes a call to the IP telephone set 6.

The terminal device 7 is placed close to the IP telephone set 6 and operated by an operator of the IP telephone set 6.

The third embodiment described above is different from the first embodiment in that the terminal device 7 is connected to the network and the terminal device 7 and the voiceprint collation server 2 are connected to each other through the network.

The IP telephone set 6 receives a call from the telephone set 3. Based on an operation of the operator, the IP telephone set 6 receives a received signal (VoIP signal) transmitted from the caller, who is making a call using the telephone set 3, and transfers this received signal to the voiceprint collation server 2. The terminal device 7 receives and outputs data on the caller's past call, which is transmitted from the voiceprint collation serer 2 in response to the transfer described above.

The voiceprint collation server 2 receives the VoIP signal transferred from the IP telephone set 6 and fetches voiceprint data from this VoIP signal. Thereafter, the voiceprint collation server 2 searches for data on the caller's past call by use of the fetched voiceprint data as a search key and transmits this searched call data to the terminal device 7.

Based on an operation of the operator, the terminal device 7 creates call data on the current call from the caller and sends this current call data to the voiceprint collation server 2. The voiceprint collation server 2 receives the current call data from the terminal device 7. Thereafter, the voiceprint collation server 2 stores the received call data together with the data on the caller's past call in a manner that the received call data is related to the voiceprint data fetched from the VoIP signal.

As shown in FIG. 9, the IP telephone set 6 is different from the IP telephone set 1 in that the storage unit 27 of the IP telephone set 1 shown in FIG. 2 is deleted and the functions of the display unit 26 and operation unit 25 of the IP telephone set 1 are partly placed under the control of the terminal device 7.

An operation unit 92 receives operations of the operator such as input of a telephone number and picking up/hanging up of the phone. Moreover, the operation unit 92 includes a transfer button and outputs a transfer instruction to transfer the received signal (VoIP signal) transmitted from the telephone set 3 (opposite speaker), to the voiceprint collation server 2.

A display unit 93 performs display of states of the IP telephone set 6 and the like.

A control unit 91 controls communication with the telephone set 3, communication with the voiceprint collation server 2 and the functions of the IP telephone set 6. Moreover, the control unit 91 receives the transfer instruction outputted by the operation unit 92 and instructs the transfer circuit 22 to transfer.

The terminal device 7 includes operation means, display means and storage means.

Based on an operation of the operator, the operation means creates call data and stores the data in the storage means.

The storage means stores the call data created based on the operation of the operator.

The display means performs display of the past call data, display of the call data created based on the operation of the operator and the like.

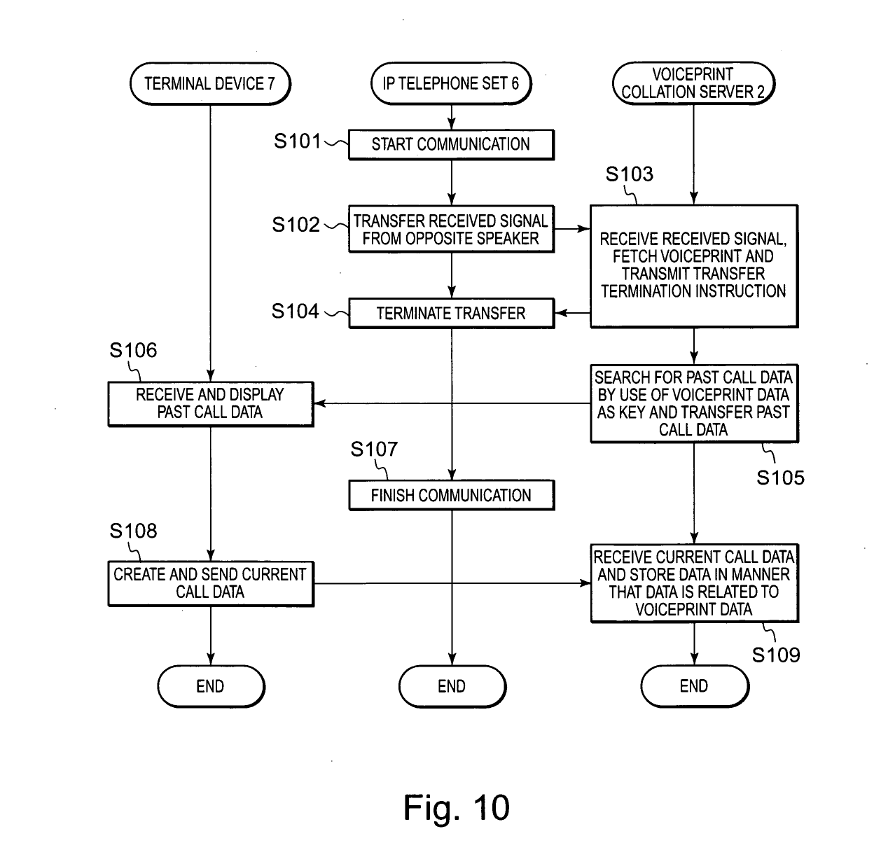

Next, with reference to FIG. 10, detailed description will be given of operations of the speaker call-history presentation system of this embodiment.

FIG. 10 is a flowchart showing one example of the operations of this embodiment.

In FIG. 8, Steps 101 to 105 of FIG. 10 are the same as Steps 41 to 45 in the description of the operations of the first embodiment shown in FIG. 1.

Next, in Step 106 of FIG. 10, the terminal device 7 having an IP address included in the VoIP signal receives the data on the caller's past call or a “notification indicating the first call” from the voiceprint collation server 2, and displays the past call data or the notification on the display means thereof.

In Step 107 of FIG. 10, when the contents displayed on the display means are the past call data, the operator of the IP telephone set 6 knows contents of the call made by the caller in the past, by reading the past call data. Thus, the operator can promptly determine whether or not the current call is a suspicious one intended for solicitation, sales and the like of, such as real estate, stocks, religions and the like. Accordingly, when the call is such a suspicious call, the operator can deal with the call by immediately sending a negative reply, hanging up the phone, finishing the call or the like.

Moreover, when the contents displayed on the display means are the “notification indicating the first call”, the operator of the IP telephone set 6 determines the purpose of the call and deals therewith while listening to the caller. Thereafter, the operator hangs up the phone and finishes the call.

In Step 108 of FIG. 10, after the call between the IP telephone set 6 and the telephone set 3 is finished, the terminal device 7 creates call data on this call based on an operation of the operator of the IP telephone set 6. For example, the operator operates the operation means to create call data, including the name of the caller, the date and time of the call, a brief summary of the call and the like, as text data and stores the call data in the storage means. Thereafter, the operator sends the call data stored in the storage means to the voiceprint collation server 2.

In Step 109 of FIG. 10, upon receipt of the call data sent by the terminal device 7 in Step 108, the voiceprint collation server 2 stores the call data in the database. In the database, the call data described above is stored in a manner that the call data is related to the voiceprint data fetched from the latest VoIP signal transferred from the IP telephone set 6. When the data on the caller's past call is already stored in the database, the call data described above is stored therein together with the past call data.

The IP telephone sets of the first to third embodiments described above may be controlled by a computer such as a CPU which executes a preinstalled program. The preinstalled program may be set in a floppy disk®, an external memory such as a compact disk, a ROM (read only memory) storing the preinstalled program, or the like.

As described above, according to the present invention, the IP telephone set or the terminal device displays the data on the past call of the caller who makes the call to the IP telephone set. By reading the displayed data on the caller's past call, the operator of the IP telephone set knows the purpose of the call. Thus, the operator of the IP telephone set can promptly determine whether or not the call is a suspicious one. Consequently, the present invention helps the operator deal with suspicious calls.

Moreover, according to the present invention, when the call made to the IP telephone set is a suspicious call, the call data on this call is stored in the voiceprint collation server in a manner that the call data is related to the voiceprint data. Consequently, it is possible to put psychological pressure such as “if a suspicious call is made, voiceprint data of a person who makes this suspicious call and his/her call data are recorded” on the party who makes the suspicious call. Consequently, the present invention helps prevent suspicious calls.

While the present invention has been described in connection with certain preferred embodiments, it is to be understood that the subject matter encompassed by the present invention is not limited to those specific embodiments. On the contrary, it is intended to include all alternatives, modifications and equivalents as can be included within the spirit and scope of the following claims.

1. A speaker call-history presentation system including an IP telephone set and a voiceprint collation server connected to the IP telephone set via a network, comprising:
the IP telephone set which transfers a received signal transmitted from a caller, who is making a call, to the voiceprint collation server and receives and displays call data on the caller's past call, which is transmitted from the voiceprint collation server in response to the transfer; and
the voiceprint collation server which receives the received signal transferred from the IP telephone set, fetches voiceprint data from the received signal and transmits the call data on the caller's past call, which is related to the voiceprint data, to the IP telephone set.

2. The speaker call-history presentation system, according to claim 1,
wherein the IP telephone set sends call data on a current call from the caller, to the voiceprint collation server, and
the voiceprint collation server receives the current call data sent from the IP telephone set and stores the received call data in a manner that the call data is related to the voiceprint data fetched from the received signal.

3. A speaker call-history presentation system including a terminal device, an IP telephone set connected to the terminal device and a voiceprint collation server connected to the IP telephone set through a network, comprising:
the IP telephone set which transfers a received signal transmitted from a caller, who is making a call, to the voiceprint collation server, receives data on the caller's past call, which is transmitted from the voiceprint collation server in response to the transfer, and outputs the past call data to the terminal device;
the terminal device which receives and displays the data on the caller's past call, which is outputted by the IP telephone set; and
the voiceprint collation server which receives the received signal transferred from the IP telephone set, fetches voiceprint data from the received signal and transmits the data on the caller's past call, which is related to the voiceprint data, to the IP telephone set.

4. The speaker call-history presentation system, according to claim 3,
wherein the terminal device creates call data on a current call from the caller and sends this call data to the voiceprint collation server via the IP telephone set, and
the voiceprint collation server receives the current call data from the terminal device via the IP telephone set and stores the received call data in a manner that the received call data is related to the voiceprint data fetched from the received signal.

5. A speaker call-history presentation system including an IP telephone set, a terminal device and a voiceprint collation server connected to the IP telephone set and the terminal device through a network, comprising:
the IP telephone set which transfers a received signal transmitted from a caller, who is making a call, to the voiceprint collation server;
the terminal device which receives and displays data on the caller's past call, which is transmitted from the voiceprint collation server in response to the transfer of the received signal to the voiceprint collation server by the IP telephone set; and
the voiceprint collation server which receives the received signal transferred from the IP telephone set, fetches voiceprint data from the received signal and transmits the data on the caller's past call, which is related to the voiceprint data, to the terminal device.

6. The speaker call-history presentation system, according to claim 5,
wherein the terminal device creates call data on a current call from the caller and sends this call data to the voiceprint collation server, and
the voiceprint collation server receives the current call data sent from the terminal device and stores the received call data in a manner that the received call data is related to the voiceprint data fetched from the received signal.

7. The speaker call-history presentation system, according to claim 1,
wherein the received signal transmitted from the caller, who is making a call, is a VoIP (Voice over Internet Protocol) signal.

8. The speaker call-history presentation system, according to claim 1,
wherein the call data includes the name of the caller, the date and time of the call, and a brief summary of the call.

9. An IP telephone set comprising:
received signal transfer circuit which transfers a received signal transmitted from a caller, who is making a call, to a transfer destination having a predetermined IP address; and
call data display device which receives data on the caller's past call, which is transmitted from the transfer destination in response to the transfer, and displaying the past call data.

10. The IP telephone set according to claim 9, wherein the received signal transfer circuit includes
transfer instruction device which outputs a transfer signal having an instruction to transfer and
transfer circuit which receives the transfer signal from the transfer instruction device and transferring the received signal transmitted from the caller, who is making the call, to the transfer destination.

11. The IP telephone set according to claim 9, wherein the received signal transmitted from the caller, who is making the call, is a VoIP signal.

12. The IP telephone set according to claim 9, wherein the call data includes the name of the caller, the date and time of the call, and a brief summary of the call.

13. An IP telephone system comprising:
an IP telephone set which transfers a received signal transmitted from a caller, who is making a call, to a transfer destination having a predetermined IP address, receives data on the caller's past call, which is transmitted from the transfer destination in response to the transfer, and outputs the past call data; and
a terminal device which receives and displays the data on the caller's past call, which is outputted by the IP telephone set.

14. The IP telephone system according to claim 13, wherein the IP telephone set includes
transfer instruction device which outputs a transfer signal having an instruction to transfer and
transfer circuit which receives the transfer signal from the transfer instruction device, transferring the received signal transmitted from the caller, who is making the call, to the transfer destination, receiving the data on the caller's past call, which is transmitted from the transfer destination in response to the transfer, and outputting the past call data.

15. An IP telephone system comprising:
an IP telephone set which transfers a received signal transmitted from a caller, who is making a call, to a transfer destination having a predetermined IP address; and
a terminal device which receives data on the caller's past call, which is transmitted from the transfer destination in response to transfer of the received signal transmitted from the caller by the IP telephone set, and displays the past call data.

16. The IP telephone system according to claim 15, wherein the IP telephone set includes
transfer instruction device outputs a transfer signal having an instruction to transfer and
transfer circuit which receives the transfer signal from the transfer instruction device and transferring the received signal transmitted from the caller, who is making the call, to the transfer destination.

17. The IP telephone system according to claim 13, wherein the received signal transmitted from the caller, who is making the call, is a VoIP signal.

18. The IP telephone system according to claim 13, wherein the call data includes the name of the caller, the date and time of the call, and a brief summary of the call.

19. An IP telephone method for presenting a call-history of a caller who makes a call to an IP telephone set, comprising:
receiving a received signal transmitted from the caller, who is making a call, and transferring the received signal to a transfer destination having a predetermined IP address; and
receiving data on the caller's past call, which is sent from the transfer destination in response to the transfer, and displaying the past call data.

20. An IP telephone method for presenting a call-history of a caller who makes a call to an IP telephone set, comprising:
receiving a received signal transmitted from the caller, who is making a call, and transferring the received signal to a transfer destination having a predetermined IP address; and
receiving data on the caller's past call, which is sent in response to the transfer, from the transfer destination, and outputting this call data so as to have the call data displayed.

21. The IP telephone method according to claim 19, wherein the received signal transmitted from the caller, who is making the call, is a VoIP signal.

22. The IP telephone method according to claim 19, wherein the call data includes the name of the caller, the date and time of the call, and a brief summary of the call.

23. A speaker call-history presentation method for presenting a call-history of a caller who makes a call to an IP telephone set, comprising:
transferring a received signal transmitted from the caller, who is making a call, by the IP telephone set;
receiving the received signal transferred from the IP telephone set and fetching voiceprint data from this received signal by a voiceprint collation server;
transmitting data on the caller's past call, which is related to the fetched voiceprint data, to the IP telephone set by the voiceprint collation server; and
receiving and displaying the data on the caller's past call, which is transmitted from the voiceprint collation server, by the IP telephone set.

24. The speaker call-history presentation method according to claim 23, further comprising:
sending call data on a current call from the caller, to the voiceprint collation server by the IP telephone set; and
receiving the current call data sent from the IP telephone set and storing the received call data in a manner that the received data is related to the voiceprint data fetched from the received signal, by the voiceprint collation server.

25. A speaker call-history presentation method for presenting a call-history of a caller who makes a call to an IP telephone set, comprising:
transferring a received signal transmitted from the caller, who is making a call, by the IP telephone set;
receiving the received signal transferred from the IP telephone set and fetching voiceprint data from this received signal by a voiceprint collation server;
transmitting data on the caller's past call, which is related to the fetched voiceprint data, to the IP telephone set by the voiceprint collation server;
receiving and outputting the data on the caller's past call, which is transmitted from the voiceprint collation server, by the IP telephone set; and
receiving and displaying the data on the caller's past call, which is outputted by the IP telephone set, by a terminal device.

26. The speaker call-history presentation method according to claim 25, further comprising:
creating call data on the current call from the caller and sending this call data to the IP telephone set by the terminal device;
receiving the current call data and sending the data to the voiceprint collation server by the IP telephone set; and
receiving the current call data and storing the received call data in a manner that the received call data is related to the voiceprint data fetched from the received signal, by the voiceprint collation server.

27. A speaker call-history presentation method for presenting a call-history of a caller who makes a call to an IP telephone set, comprising:
transferring a received signal transmitted from the caller, who is making a call, by the IP telephone set;
receiving the received signal transferred from the IP telephone set and fetching voiceprint data from this received signal by a voiceprint collation server;
transmitting data on the caller's past call, which is related to the fetched voiceprint data, by the voiceprint collation server; and
receiving and displaying the data on the caller's past call, which is transmitted from the voiceprint collation server, by a terminal device.

28. The speaker call-history presentation method according to claim 27, further comprising:
creating call data on the current call from the caller and sending this call data to the voiceprint collation server by the terminal device; and
receiving the current call data and storing the received call data in a manner that the received call data is related to the voiceprint data fetched from the received signal, by the voiceprint collation server.

29. The speaker call-history presentation method according to claim 23, wherein the received signal transmitted from the caller, who is making the call, is a VoIP signal.

30. The speaker call-history presentation method according to claim 23, wherein the call data includes the name of the caller, the date and time of the call, and a brief summary of the call.

31. A program for causing a computer to realize a function of presenting a call-history of a caller who makes a call to an IP telephone set, the program causing the computer to execute:
receiving a received signal transmitted from the caller, who is making a call, and transferring the received signal to a transfer destination having a predetermined IP address; and
receiving data on the caller's past call, which is sent from the transfer destination in response to the transfer, and displaying the past call data.

32. A program for causing a computer to realize a function of presenting a call-history of a caller who makes a call to an IP telephone set, the program causing the computer to execute:
receiving a received signal transmitted from the caller, who is making a call, and transferring the received signal to a transfer destination having a predetermined IP address; and
receiving data on the caller's past call, which is sent in response to the transfer, from the transfer destination, and outputting this call data so as to have the call data displayed.

33. The program according to claim 31, wherein the received signal transmitted from the caller, who is making the call, is a VoIP signal.

34. The program according to claim 31, wherein the call data includes the name of the caller, the date and time of the call, and a brief summary of the call.
